(19) United States
(12) Patent Application Publication
(10) Pub. No.: US 2004/0198454 A1
(43) Pub. Date: Oct. 7, 2004

(54) Communications blocking based on a remote no-call list

(76) Inventors: David L. Chavez, Thornton, CO (US); Kevin S. Cripps, Westminster, CO (US); Ryan S. Wallach, Westminster, CO (US)

Correspondence Address: Docket Administrator (Room 1N-391), Avaya Inc., 307 Middletown-Lincroft Road, Lincroft, NJ, 07738, US

(21) Appl. No.: 10/353,578

(22) Filed: Jan. 30, 2003

Related U.S. Application Data
(60) Provisional application No. 60/423,948, filed on Nov. 4, 2002.

(51) Int. Cl. H04Q 7/20

(52) U.S. Cl. 455/565; 455/414.1

(57) ABSTRACT

A plurality of private branch exchanges (PBXs 110, 120) for placing outbound solicitation calls share use of a “no-call list” database (160) to which they are connected by a private telephone network (130) and a call-admitter server (150). When a call is initiated (200) at a PBX to a telephone number, the PBX queries (202) the server regarding whether the call is allowed. In response, the server accesses (302) the database to determine if the telephone number is in the database. If so, the server returns (308) a response blocking the call; if not, the server returns (306) a response allowing the call to proceed. The PBX responds (208, 210) accordingly. If the caller overrides (218) blocking of the call, the PBX notifies (222) the server and allows (126) the call to proceed, and the server logs (312) the override.

### Cross Reference to Related Applications

This application claims the benefit of U.S. Provisional Application No. 60/423, 948, filed Nov. 4, 2002.

### TECHNICAL FIELD

This invention relates to call centers, outbound dialing systems, and other outbound-communication-generating entities.

### BACKGROUND OF THE INVENTION

Enterprises need to block outgoing telecommunications—usually phone calls—to people who have had their electronic addresses—usually telephone numbers—entered on a “no-call list” to indicate their desire to not be contacted. Software vendors who specialize in outbound dialing applications for call centers usually add these no-call lists as parameters to their applications such that their applications will not select telephone numbers on the no-call lists in generating outbound calls. But some enterprises do not use these applications; they rely on paper or electronic databases or other closed data stores for sources of telephone numbers that their agents call to solicit business, and therefore find it difficult to comply with not calling people listed on the no-call lists.

Most private branch exchanges (PBXs) have the capability to block calls to specific kinds of telephone numbers—such as “900”—prefix telephone numbers, for example—or to specific-ranges of numbers. But telephone numbers on no-call lists do not fit neatly into such categories. And even PBXs that have the capability to block calls to individual selected numbers do not have the capacity to store and block calls to millions or even tens of millions of phone numbers, as is needed by no-call lists, and they typically have no easy way of updating their stores of these blocked numbers on a constant basis. Local storage of the no-call lists, their huge size, the proprietary and/or complicated ways of updating them on PBXs, the number of PBXs that they must be maintained on, and the difficulties of keeping all of the copies synchronized all make compliance with no-call lists unwieldy and often prohibitively expensive for enterprises.

### SUMMARY OF THE INVENTION

This invention is-directed to solving these and other problems and disadvantages of the prior art. According to the invention, at least one system for effecting outbound solicitation communications to endpoints having addresses is connected to a database of addresses of endpoints that are not to be solicited, by a communications network and a server for accessing the database which server is physically distinct from the at least one system. In response to initiation on a system of a communication to an address, the system queries the server via the network regarding whether the communication is allowed, responds to a first type of response to the query received from the server via the network by blocking the communication from proceeding, and responds to a second type of response to the query received from the server via the network by allowing the communication to proceed. In response to receipt of the query from the system via the network, the server accesses the database and determines whether the address is in the database. If so, the server sends the first type of response to the querying system via the network; if not, the server sends the second type of response to the querying system via the network. Preferably, in response to an override of the blocking of the communication, the system informs the server thereof and allows the communication to proceed. The server responds to the informing by logging the override.

While the invention has been characterized in terms of method, it also encompasses apparatus that performs the method. The apparatus preferably includes an effector—any entity that effects the corresponding step, unlike a means—for each step. The invention further encompasses any computer-readable medium containing instructions which, when executed in a computer, cause the computer to perform the method steps.

### BRIEF DESCRIPTION

These and other features and advantages of the present invention will become more apparent from the following description of an illustrative embodiment of the invention considered with the drawing wherein:

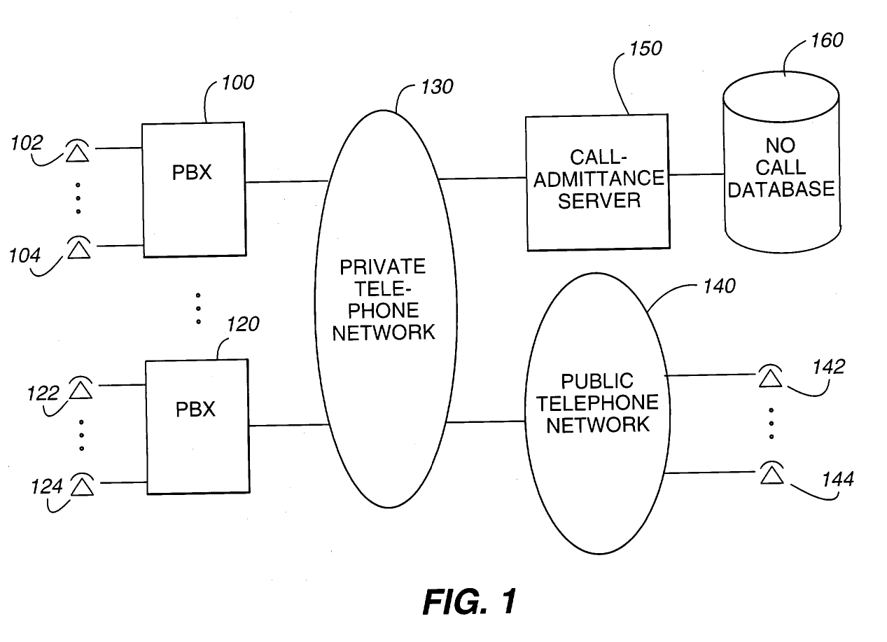

FIG. 1 is a block diagram of a communications system that includes an illustrative embodiment of the invention;

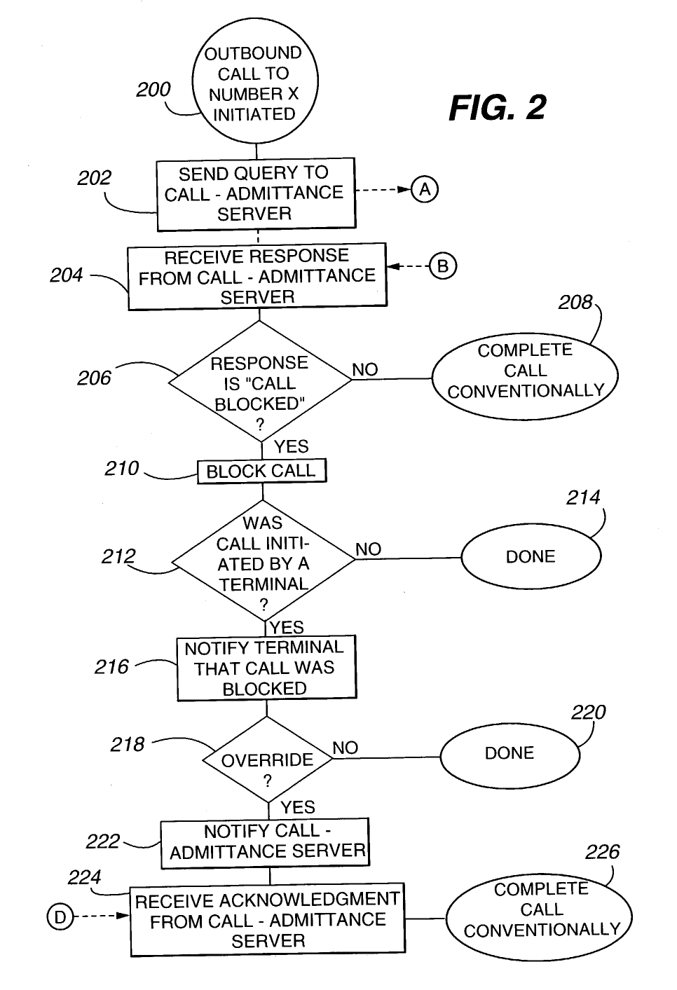

FIG. 2 is a functional flow diagram of actions performed by PBXs of the communications system of FIG. 1; and

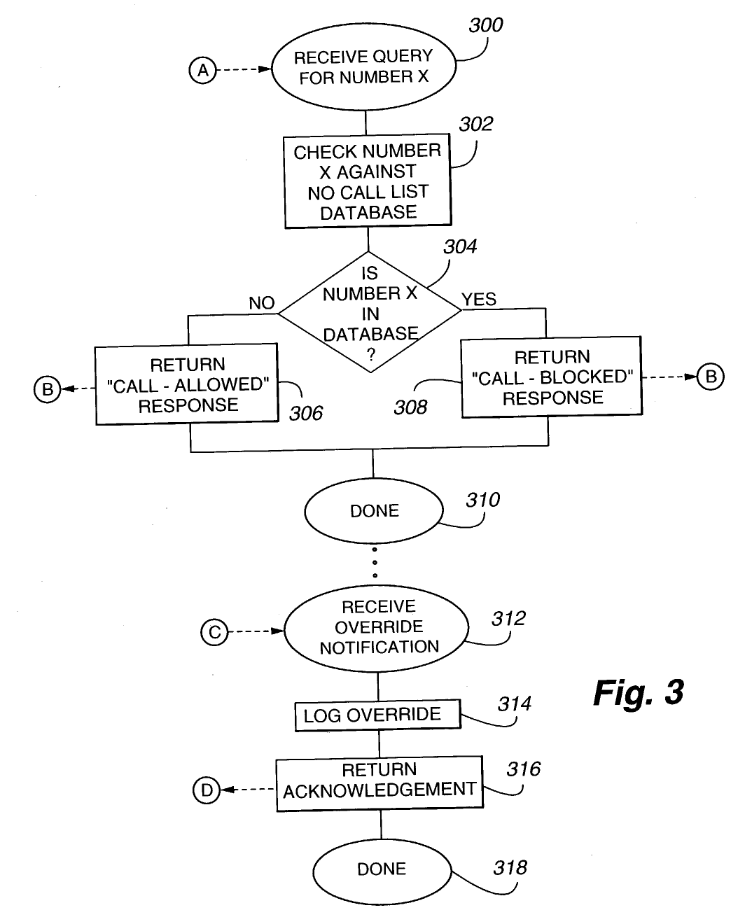

FIG. 3 is a functional flow diagram of actions performed by a call-admittance server of the communications system of FIG. 1.

### DETAILED DESCRIPTION

FIG. 1 shows an illustrative communications system. It comprises the public telephone network 140 and an enterprise's private telephone network 130 connected thereto. Public telephone subscriber's terminals 142-144 are served by network 140. Private telephone network 130 includes a call center that comprises one or more auto-dialer-equipped PBXs 100, 120 each serving its own plurality of call center agents' terminals 102-104, 122-124. Users of terminals 102-104, 122-124 and/or the dialers of PBXs 100, 120 generate outbound calls to terminals 142-144 and PBXs 100, 120 connect answered calls to agents' terminals 102-104, 122-124 for servicing, as is conventional. PBXs 100, 120 are illustratively stored-program-controlled machines comprising storage for storing data and programs and a processor for using the data and executing the programs from the storage, such as the Avaya Definity® PBXs.

According to the invention, a server 150, called a call-admitter server, and a no-call database 160 are connected to private telephone network 130 and made accessible to PBXs 100, 120. No-call database 160 is either a public or a private database that contains the no-call list of telephone numbers of people who do not wish to be solicited. Server 150 provides electronic access to no-call database 160. Server 150 is a stored-program-controlled machine having a suitable storage for storing data and programs and a processor for using the data and executing the programs from the storage. No-call database 160 centrally serves all PBXs 110, 120, thereby providing only one place in the enterprise where the no-call list has to be kept, maintained, and updated, and eliminates the problem of keeping multiple copies of the no-call lists synchronized. Of course, duplicate no-call list databases may be kept for reliability purposes. Likewise, a plurality of servers 150 may exist in private network 130, either for use by different sets of PBXs 100, 120, or for purposes of reliability, so that if one server 150 fails or cannot be reached, another may be used instead. Before a PBX 100, 120 places an outbound call to a telephone number in the public telephone network 140, it places a query data call—an H.323 call, for example—through private telephone network 130 to server 150 to determine whether the public-network call may be placed, and comports itself according to the response that it receives from server 150. This is shown in FIGS. 2 and 3. FIG. 2 shows actions performed by a PBX 100, 120, while FIG. 3 shows actions performed by server 150.

When an outbound call is initiated at a PBX 100, 120—whether by the auto-dialer of the PBX or by a user of a terminal 102-104 or 122-124—, at step 200 of FIG. 2, the originating PBX 100, 120 sends a query containing the called number to server 150, at step 202. Illustratively, the query is sent as a data call, such as an H.323 call, by the originating PBX 100, 120 through private telephone network 130 to server 150. PBXs 100, 120 may be administered to place all outgoing calls over trunks of network 130 that lead to server 150, in which case conventional software of PBXs 100, 120 need not be modified to cause them to contact server 150. Alternatively, PBXs 100, 120 may contact server 150 over a computer telephony integration (CTI) link, either directly or through an adjunct processor (not shown), and either through network 130 or through a data network such as a local area network, (also not shown).

Upon receiving the query from a PBX 100, 120, at step 300 of FIG. 3, server 150 queries no-call database 160 with the called number, at step 302, to determine if the called number is or is not contained in database 160, at step 304. If the called number is not in database 160, the call may proceed, and so server 150 sends a “call allowed” response to the originating PBX 100, 120, at step 306. This response may take the form of a call-redirection request to cause the originating PBX 100, 120 to redirect the originating call from a trunk of network 130 that is connected to server 150 to a trunk of network 130 that is connected to public telephone network 140. If the called number is in database 160, as determined at step 304, the call may not proceed, and so server 150 sends a “call blocked” response to the originating PBX 100, 120, at step 308. Following step 306 or 308, server 150 is normally done with the call, at step 310.

Returning to FIG. 2, when the originating PBX 100, 120 receives the response from server 150, at step 204, it checks if the response is “call blocked”, at step 206. If not, the originating PBX 100, 120 completes the call to the called number x in a conventional manner at step 208. For example, if the received response was to redirect the call to a trunk leading to public network 140, the originating PBX 100, 120 does so at step 208. If the response received from server 150 is “call blocked”, as determined at step 206, originating PBX 100, 120 blocks the call, at step 210, in a conventional manner. If the call had been originated by the auto-dialer of PBX 100, 120, as indicated at step 212, PBX 100, 120 is done with the call, at step 214. But if the call had been originated at one of the terminals 102-104, 122-124, originating PBX 100, 120 connects the originating terminal to an announcement that advises the agent user of the originating terminal that the call has been blocked, at step 216. At this point, the agent may override the call blocking. For example, the call may be a personal call of the agent, or the called party may be a customer of the enterprise, in which case the no-call requirement does not apply. Illustratively, the agent may override the call-blocking by dialing the call again, but this time with a prefix that serves as a call-block override feature activation code (FAC). If the agent does not override the blocking, as determined at step 218, originating PBX 100, 120 is done with the call, at step 220. But if originating PBX 100, 120 determines, at step 218, that the agent is overriding the blocking, it notifies server 150 thereof, at step 222. Notification of server 150 may take the same form as the query at step 202—for example, sending an H.323 call to server 150 or placing the outgoing call to number x preceded by the blocking override FAC over a trunk leading to server 150.

If and when server 150 receives the blocking override notification, at step 312 of FIG. 3, it makes a record thereof in an override log, at step 314, recording, inter alia, the calling and called numbers and the time of the call. If the override notification took the form of connecting the originated call with the override FAC to server 150, server responds to originating PBX 100, 120 with a redirection request to redirect the call to public network 140, at step 316. Otherwise, server 150 merely returns an acknowledgement of receipt of the override to originating PBX 100, 120, at step 316. Server 150 is then done with the call, at step 318.

Upon receiving the response from server 150, at step 124 of FIG. 2, originating PBX 100, 120 conventionally completes the call to the called number, at step 126, for example by redirecting the call from server 150 to public network 140. The call then proceeds conventionally.

Of course, various changes and modifications to the described illustrative embodiment of the invention will be apparent to those skilled in the art. For example, use of the invention is not limited to telephony networks, but may be used in any communications network including, for example, a virtual private network (VPN), a local, metropolitan, or wide area network (LAN, MAN, WAN), the Internet, or another data network. Hence, the no-call list may be a list of addresses other than telephone numbers, such as Internet or data-network addresses. Correspondingly, the soliciting communication need not be a voice telephone call but may be a fax call, a voice-over-Internet Protocol (VoIP) call, a data call, a multimedia call, or a message in any medium. The PBXs may be administered to block outgoing calls if they cannot reach a call admitter server to screen the calls; alternatively only “normal” calls should be blocked but “override” calls should be allowed to proceed, with a warning being given to the caller in both cases, and an optional capability to administratively (locally) block the “override” calls may be provided. Such changes and modifications maybe made without departing from the spirit and the scope of the invention. It is therefore intended that such changes and modifications be covered by the accompanying claims except insofar as limited by the prior art.

What is claimed is:

1. An apparatus comprising:
at least one system for effecting outbound solicitation communications to endpoints having addresses;
a database of addresses of endpoints that are not to be solicited;
a server physically distinct from the at least one system, for accessing the database;
a communications network communicatively connecting the at least one system with the server;
each at least one system having means responsive to initiation of a communication to an address for querying the server via the network regarding whether the communication is allowed, and responsive to a response from the server to the query received via the network for either blocking the communication from proceeding or allowing the communication to proceed; and
the server having means responsive to the query received from a system via the network for determining whether the address is or is not in the database, responsive to determining that the address is in the database for sending to the system the response to block the communication, and responsive to determining that the address is not in the database for sending to the system the response to allow the communication to proceed.

2. The apparatus of claim 1 wherein:
the at least one system comprises
a plurality of the systems which share use of the network, the server, and the database.

3. The apparatus of claim 1 wherein:
the network is a private network of an enterprise; and
the server is a private server of the enterprise.

4. The apparatus of claim 3 wherein:
the database is a private database of the enterprise.

5. The apparatus of claim 3 wherein:
the database is a public database.

6. The apparatus of claim 1 wherein:
the at least one system comprises at least one private branch exchange;
the communication is a telephone call;
the database comprises a no-call list; and
the addresses are telephone numbers.

7. The apparatus of claim 6 wherein:
the network comprises a private telephone network of an enterprise.

8. The apparatus of claim 7 wherein:
the query comprises the telephone call being directed to the server; and
the response allowing the communication to proceed comprises a directive to the PBX to redirect the telephone call to a public telephone network.

9. The apparatus of claim 1 further comprising;
means in each said system responsive to an override of blocking of the communication, for informing the server and allowing the communication to proceed; and
means in the server responsive to the informing, for logging the override.

10. A method in a communications network comprising at least one system for effecting outbound solicitation communications to endpoints having addresses, a database of addresses of endpoints that are not to be solicited, a server physically distinct from the at least one system, for accessing the database, and a communications network communicatively connecting the at least one system with the server, comprising:
in response to initiation on a system of a communication to an address, the system querying the server via the network regarding whether the communication is allowed;
in response to a first response to the query received from the server via the network, blocking the communication from proceeding; and
in response to a second response to the query received from the server via the network, allowing the communication to proceed.

11. The method of claim 10 further comprising:
in response to receipt of the query from the system via the network, the server accessing the database and determining whether the address is in the database;
in response to determining that the address is in the database, the server sending the first response to the system via the network; and
in response to determining that the address is not in the database, the server sending the second response to the system via the network.

12. The method of claim 10 further comprising:
in response to an override of the blocking of the communication, the system informing the server thereof and allowing the communication to proceed.

13. The method of claim 11 further comprising:
in response to an override of the blocking of the communication, the system informing the server thereof and allowing the communication to proceed; and
in response to the informing, the server logging the override.

14. A method in a communications network comprising at least one system for effecting outbound solicitation communications to endpoints having addresses, a database of addresses of endpoints that are not to be solicited, a server physically distinct from the at least one system, for accessing the database, and a communications network communicatively connecting the at least one system with the server, comprising:
in response to receipt, via the network from a system on which a communication to an address was initiated, of a query regarding whether the communication is allowed, the server accessing the database and determining whether the address is in the database;
in response to determining that the address is in the database, the server sending to the system via the network a first response blocking the communication from proceeding; and
in response to determining that the address is not in the database, the server sending to the system via the network a second response allowing the communication to proceed.

15. The method of claim 14 further comprising:
in response to initiation on the system of the communication to the address, the system querying the server via the network regarding whether the communication is allowed;
in response to the first response to the query received from the server via the network, the system blocking the communication from proceeding; and
in response to the second response to the query received from the server via the network, the system allowing the communication to proceed.

16. The method of claim 15 further comprising:
in response to an override of the blocking of the communication, the system informing the server thereof and allowing the communication to proceed.

17. The method of claim 14 further comprising:
in response to being informed by the system of an override of the blocking of the communication, the server logging the override.

18. A private branch exchange (PBX) comprising:
an effector responsive to initiation at the PBX of an outbound call to a telephone number, of querying a server that is physically distinct from the PBX over a communications network connecting the PBX to the server regarding whether the telephone number is included in a database of telephone numbers that do not wish to be called; and
an effector responsive to receipt from the server via the network of a response indicating that the telephone number is in the database, of blocking the call from proceeding, and responsive to receipt from the server via the network of a response indicating that the telephone number is not in the database, of allowing the call to proceed.

19. The PBX of claim 18 further comprising:
an effector responsive to an override of blocking of the call, of allowing the call to proceed and informing the server via the network of the override.

20. A computer-readable medium containing instructions which, when executed in a computer, cause the computer to perform the following actions:
in response to initiation at a private branch exchange (PBX) of an outbound call to a telephone number, querying a server that is physically distinct from the PBX over a communications network connecting the PBX to the server regarding whether the telephone number is included in a database of telephone numbers that do not wish to be called;
in response to receipt via the network of a response from the server indicating that the telephone number is in the database, causing the PBX to block the call from proceeding; and
in response to receipt via the network of a response from the server indicating that the telephone number is in the database, causing the PBX to effect the call.

21. The medium of claim 20 further containing instructions which cause the computer to perform the following actions:
in response to an override of blocking of the call, causing the PBX to effect the call; and
further in response to the override, informing the server of the override via the network.
